(19) United States
(12) Patent Application Publication
(10) Pub. No.: US 2013/0320031 A1
(43) Pub. Date: Dec. 5, 2013

(54) Tubular Package and Dispenser

(71) Applicant: Susan R. Rosenberg, Lawrence, NY (US)

(72) Inventor: Susan R. Rosenberg, Lawrence, NY (US)

(73) Assignee: API INDUSTRIES, INC., Orangetown, NY (US)

(21) Appl. No.: 13/486,140

(22) Filed: Jun. 1, 2012

(51) Int. Cl. B65D 83/00; B65G 59/00; B65D 85/671; B65D 83/08

(52) U.S. Cl. 221/1; 221/282; 221/45; 242/588.3

(57) ABSTRACT

A container for a product includes a substantially cylindrical body. The body includes two end portions and a tubular sidewall surface disposed between the two end portions. The sidewall surface includes a removable sidewall portion that, when removed, defines a sidewall opening in the sidewall surface to remove a product from the container. A method of dispensing a product from a container includes removing a removable sidewall portion of the container. The removable sidewall portion is located at a tubular sidewall surface located between two end portions of the container, thereby defining an opening in the tubular sidewall surface. A product is removed from the container via the opening.

### BACKGROUND

The subject matter disclosed herein relates to dispenser for products such as plastic bags or sheet.

A typical package and dispenser for products such as, for example, bags or sheets formed of a plastic material is a rectilinear box in which the products are enclosed. The box typically has an opening at one rectangular planar face to allow for removal of the product.

### SUMMARY

In one embodiment, a container for a product includes a substantially cylindrical body. The body includes two end portions and a tubular sidewall surface disposed between the two end portions. The sidewall surface includes a removable sidewall portion that, when removed, defines a sidewall opening in the sidewall surface to remove a product from the container.

In another embodiment, a method of dispensing a product from a container includes removing a removable sidewall portion of the container. The removable sidewall portion is located at a tubular sidewall surface located between two end portions of the container, thereby defining an opening in the tubular sidewall surface. A product is removed from the container via the opening.

These and other advantages and features will become more apparent from the following description taken in conjunction with the drawings.

### DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an embodiment of a tubular dispenser;

FIG. 2 is a cross-sectional view of an embodiment of a tubular dispenser;

FIG. 3 is a perspective view of a bag arrangement;

FIG. 4 is a perspective view of an embodiment of a tubular dispenser having an opening in a sidewall;

FIG. 5 is a perspective view of another embodiment of a tubular dispenser;

FIG. 6 is another perspective view of the tubular dispenser of FIG. 5;

FIG. 7 is a perspective view of an embodiment of a tubular dispenser having a keyhole-shaped sidewall opening;

FIG. 8 is another perspective view of an embodiment of a tubular dispenser having a keyhole-shaped sidewall opening;

FIG. 9 is a perspective view of an embodiment of an end cap for a tubular dispenser;

FIG. 10 is a perspective view of another embodiment of an end cap for a tubular dispenser; and

FIG. 11 is a perspective view of yet another embodiment of an end cap for a tubular dispenser.

The detailed description explains embodiments of the invention, together with advantages and features, by way of example with reference to the drawing.

### DETAILED DESCRIPTION

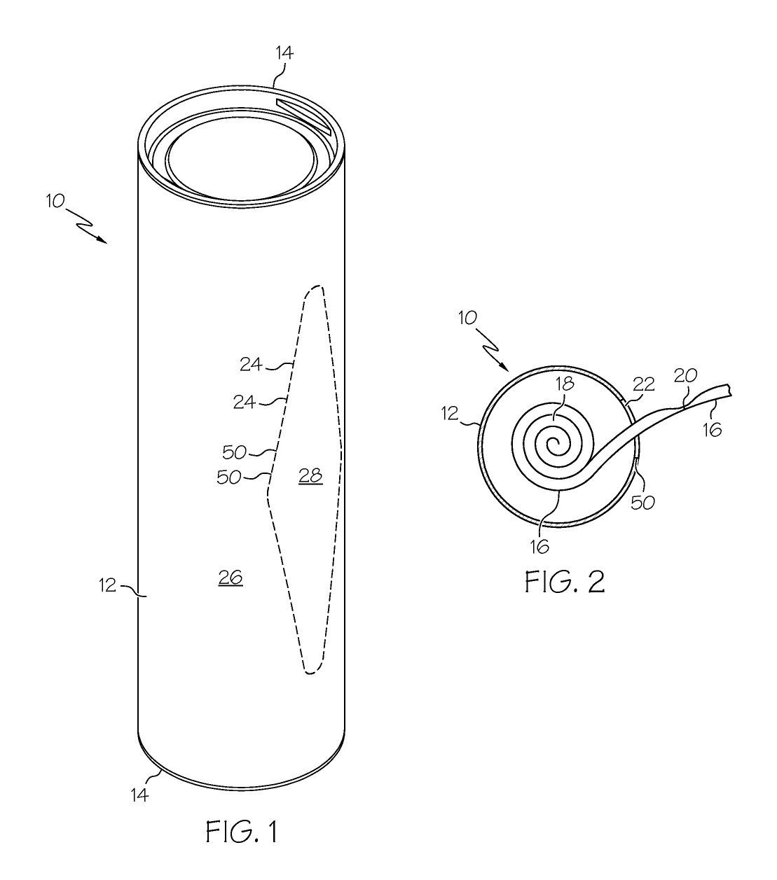

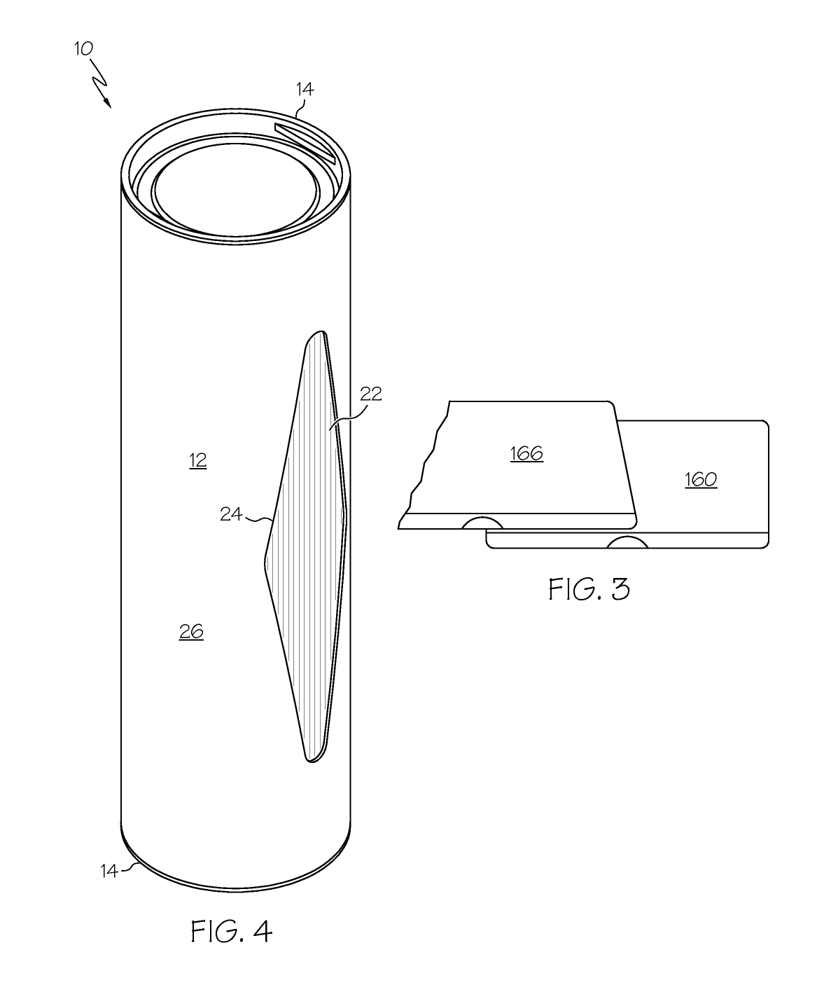

Shown in FIG. 1 is an embodiment of a package and dispenser 10. The dispenser 10 is substantially cylindrical in shape and includes a sidewall 12 and two end portions 14 to enclose a quantity of product therein. The product may be, for example as shown in FIG. 2, bags 16 utilized for storage and or disposal. In some embodiments, the bags are formed from a plastic material, and may be arranged in a roll 18 with bag perforations 20 to separate individual the bags 16 and allow for ease of removal from the dispenser 10. Alternatively, the bags 16 may be arranged in, for example, a stack with or without bag perforations 20 separating the individual bags 16. Further, as shown in FIG. 3, in alternative embodiments, the bags 16 may be interleaved in the stack or roll with a portion of a first bag 16a overlapping a portion of a second bag 16b. When the first bag 16a is removed from the dispenser 10, the second bag 16b follows, due to a static electricity interaction between the two bags 16a, 16b. Further, while the product described herein are bags 16, it is to be appreciated that other products may be contained in and dispensed from the dispenser 10, including sheets of, for example, a plastic, paper, or other material. The dispenser 10 is formed from a paper or cardboard material, but alternatively may be formed from other materials such as plastic or metal, or a combination of the above.

Referring again to FIG. 2, the dispenser 10 includes a sidewall opening 22 in the sidewall 12. The sidewall opening 22 allows for removal of the bags 16 or other product from an interior of the dispenser 10. The sidewall opening 22 is defined as shown in FIG. 1. An array of perforations 24 is located across the curving outer surface 26 of the sidewall 12 in a selected shape to define a removable portion 28 of the sidewall 12 within the array of perforations 24. The removable portion 28 is retained at the dispenser by sprues 50 between adjacent perforations 24. When the removable portion 28 is removed from the dispenser 10 at the perforations 24 by, for example, breaking or cutting the sprues 50, the sidewall opening 22 is defined by a remaining portion of the sidewall 12, as shown in FIG. 4.

In other embodiments, the removable portion 28 may be replaced by a closure over or in the sidewall opening 22. For example, the closure may be a hinged panel or door, or a replaceable tape that fits over the sidewall opening.

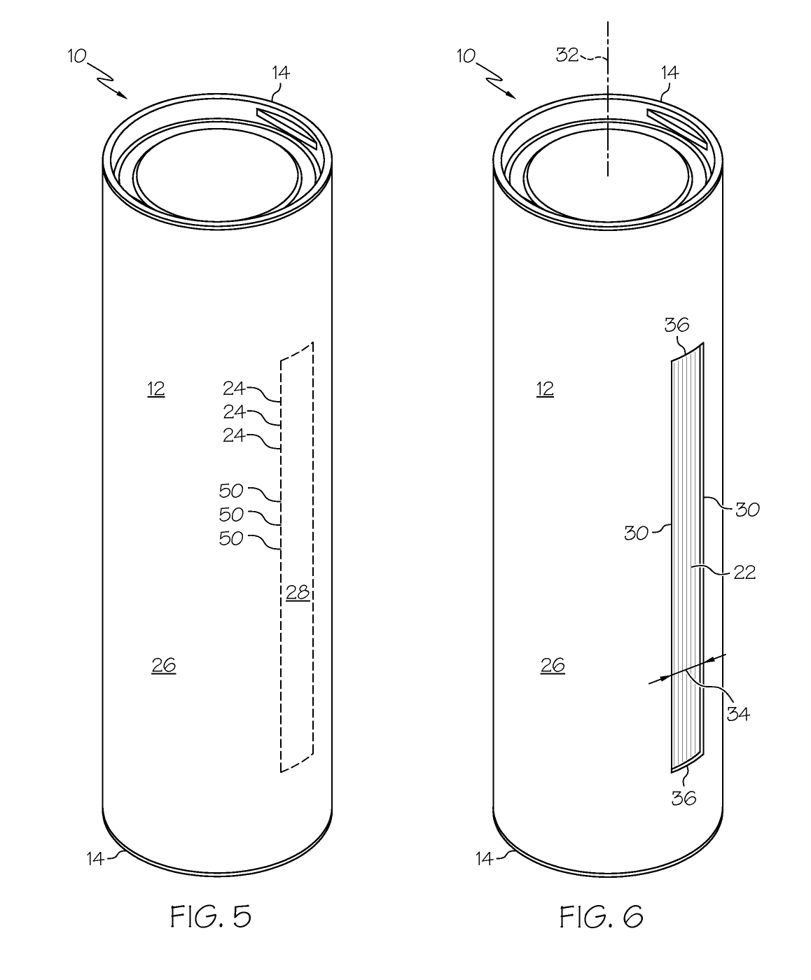

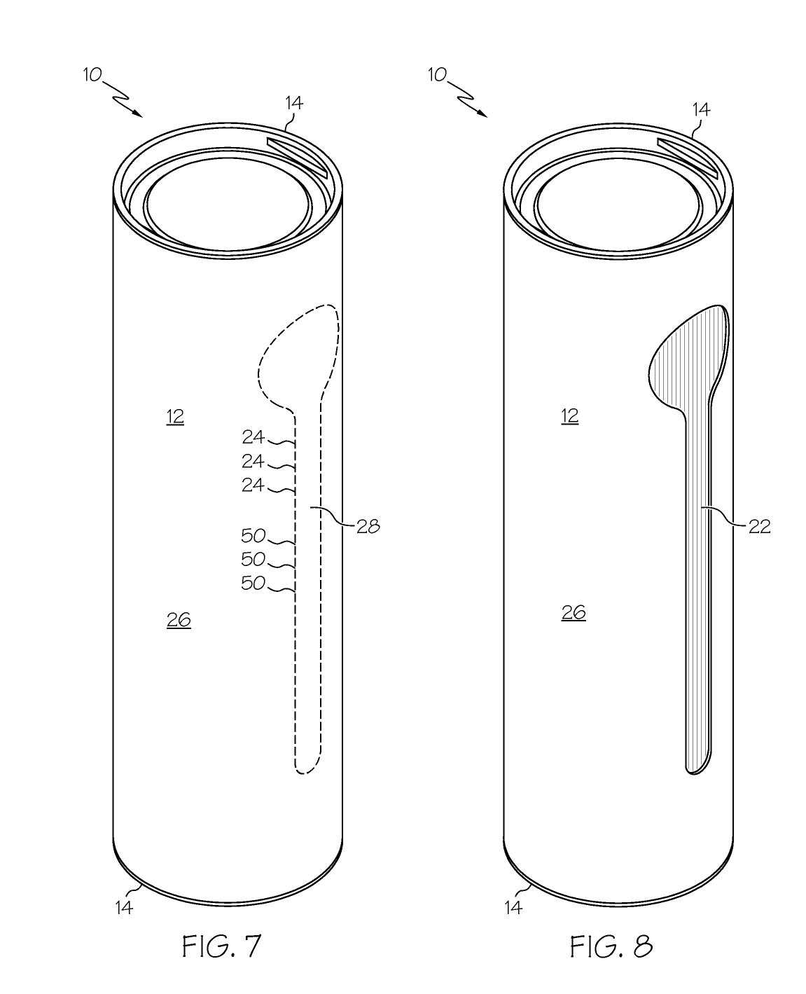

Referring now to FIGS. 5 and 6, an embodiment of the dispenser 10 is illustrated having a slotted or race-track shaped sidewall opening 22. The sidewall opening 22 of this embodiment has two parallel long-side edges 30 that, in some embodiments, extend substantially parallel to a central axis 32 of the dispenser 10. The long side edges 30 define a width 34 of the sidewall opening 22 and are connected by two curved end portions 36, which may be semicircular. Another embodiment of the dispenser 10 is shown in FIGS. 1 and 2, having a diamond-shaped removable portion 28 and sidewall opening 22, while FIGS. 7 and 8 illustrate yet another embodiment of the dispenser 10 having a keyhole-shaped sidewall opening 22 and removable portion 28. It is to be appreciated that the illustrated embodiments are merely exemplary and other sidewall opening 22 shapes, such as circular or rectangular are contemplated by the present disclosure.

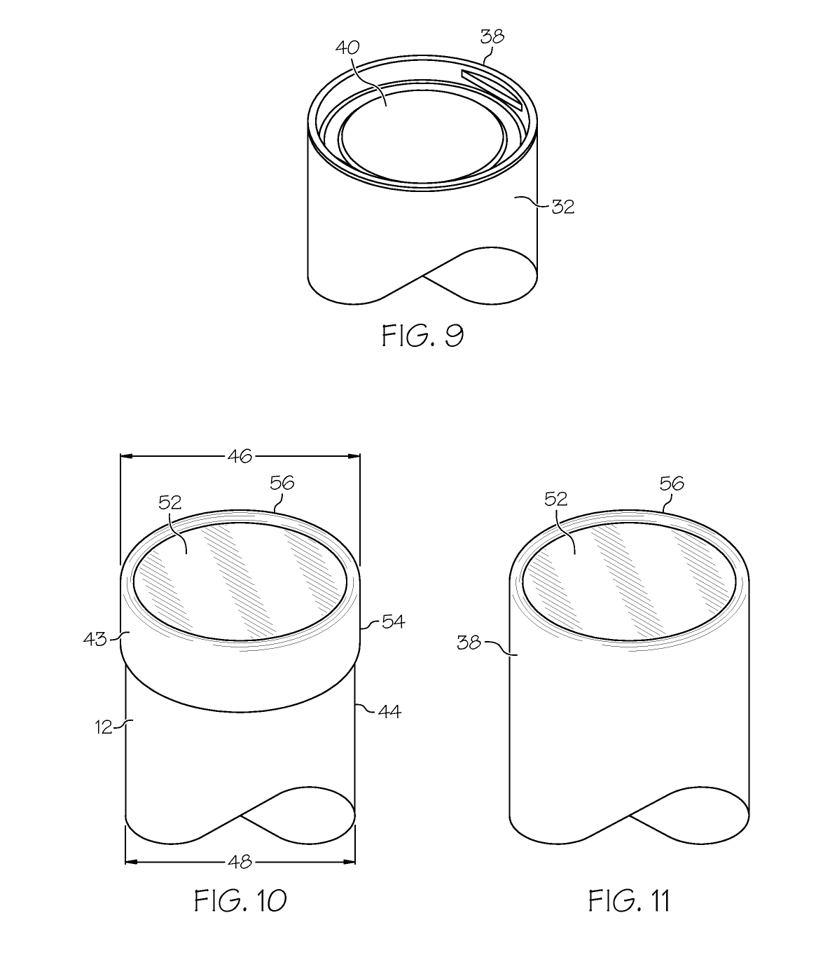

Ends 38 of the dispenser 10, to retain the product in the dispenser 10, may be of one of many configurations, as shown by the following exemplary embodiments. For example, as shown in FIG. 9, the end 38 may include a cap 40 insertable into the end 38, which is at least partially recessed onto the end 38. In another embodiment, shown in FIG. 10, an external cap 42 fits over an exterior surface 44 of the end 38, and has an inner diameter 46 equal to or greater than an end diameter 48. In some embodiments, the external cap 42 is a two-piece cap including a disc 52 that fits inside of a sleeve 54. A sleeve end 56 may be rolled over to retain the disc 52. Referring now to FIG. 11, in another embodiment the disc 52 is inserted directly into the end 38, and the end 38 is rolled over to retain the disc 452 and close the dispenser 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A container for a product comprising:
a substantially cylindrical body including:
two end portions; and
a tubular sidewall surface disposed between the two end portions, the sidewall surface including a removable sidewall portion that, when removed, defines a sidewall opening in the sidewall surface to remove a product from the container.

2. The container of claim 1, wherein the removable sidewall portion is retained at the sidewall surface by a plurality of sprues disposed between adjacent perforations of a plurality of perforations in the sidewall surface.

3. The container of claim 1, wherein the sidewall opening is one of substantially diamond-shaped, keyhole-shaped, or rectangular slot-shaped.

4. The container of claim 1, wherein at least one end portion includes an end cap to close the at least one end portion of the container.

5. The dispenser of claim 4, wherein the end cap is a disc retained in the container by the sidewall surface.

6. The container of claim 1, wherein the product is a bag or sheet.

7. A method of dispensing a product from a container comprising:
removing a removable sidewall portion of the container, the removable sidewall portion disposed at a tubular sidewall surface located between two end portions of the container, thereby defining an opening in the tubular sidewall surface; and
removing a product from the container via the opening.

8. The method of claim 7, wherein removing the removable sidewall portion of the container comprises breaking a plurality of sprues retaining the removable sidewall portion, the plurality of sprues disposed at the tubular sidewall surface between adjacent perforations of a plurality of perforations through the tubular sidewall surface.

9. The method of claim 7, wherein the product the product is a bag or sheet disposed in the container in roll form.

10. The method of claim 7, wherein the opening is one of substantially diamond-shaped, keyhole-shaped, or rectangular slot-shaped.

11. The method of claim 7, wherein at least one end portion of the container includes an end cap to close the at least one end portion of the container.
